(19) United States
(12) Patent Application Publication
(10) Pub. No.: US 2016/0018428 A1
(43) Pub. Date: Jan. 21, 2016

(54) REUSABLE BELT WITH A MATRIX OF WELLS

(71) Applicant: DOUGLAS SCIENTIFIC, LLC, Alexandria, MN (US)

(72) Inventors: Hans Alois Mische, Grey Eagle, MN (US); Darren Lynn Cook, Alexandria, MN (US)

(21) Appl. No.: 14/776,467

(22) PCT Filed: Mar. 14, 2014
(86) PCT No.: PCT/US14/28533

§ 371 Date: Sep. 14, 2015

Related U.S. Application Data
(60) Provisional application No. 61/792,556, filed on Mar. 15, 2013.

(51) Int. Cl. G01N 35/02; G01N 35/04; G01N 35/10

(52) U.S. Cl. CPC G01N 35/021; G01N 35/1002; G01N 35/04; G01N 2035/023; G01N 2035/0437

(57) ABSTRACT

A system for processing and analyzing a sample includes a belt with wells that proceeds through the system, a dispensing station that dispenses the sample and reagents into the wells of the belt, and a detection station that detects an analyte in the wells of the belt. The system further includes a wash and decontamination station for decontaminating the wells of the belt.

### CROSS-REFERENCE TO RELATED APPLICATION(S)

This application claims priority from U.S. Provisional Application No. 61/792,556, filed Mar. 15, 2013 for “ARRAY TAPE FORMATION AND ARRAY TAPE BELT” by Darren Lynn Cook et al.

### BACKGROUND

The present invention relates to inline sample processing on high throughput systems, and more specifically relates to formation of a tape with a matrix of wells and a reusable belt with a matrix of wells.

Advances in the biosciences industry have created a demand for high throughput biological sample processing and detection systems. For example, Astle, U.S. Pat. No. 6,632,653, discloses a high throughput method of performing biological assays using a tape with a matrix of wells. In a high throughput system, a liquid handling and sample processing system transfers the source and assay from microplates into a tape with a matrix of wells, seals the tape, and accumulates the tape on spools. The tape containing samples, such as biological samples, is then transferred to a water bath product and a reaction may be performed, such as polymerase chain reaction (PCR) using thermocycling. Subsequently, the tape may be loaded onto a detection instrument, which detects presence of a desired analyte, such as nucleic acid presence in a biological sample.

Tape with a matrix of wells employed in such high throughput systems is typically used once to process and detect the presence of an analyte in a single sample. After a single use, the tape is discarded. It is not reused due to contamination risks. Additionally, tape with a matrix of wells is typically formed through thermal embossing. Therefore, consumable materials like tape with a matrix of wells increase costs associated with high throughput systems due to the cost of the tape and waste disposal. With a push towards increasing reaction speeds to process even more samples at an even faster rate, tape costs could become prohibitively expensive.

### SUMMARY

A system for processing and analyzing a sample includes a belt with wells that proceeds through the system, a dispensing station that dispenses the sample and reagents into the wells of the belt, and a detection station that detects an analyte in the wells of the belt. The system further includes a wash and decontamination station for decontaminating the wells of the belt.

A method for processing and analyzing a sample in a system includes advancing a belt wells through the system to a dispensing station, dispensing a sample and reagents into the wells of the belt, advancing the belt to a detection station of the system, and detecting an analyte in the sample in the wells of the belt. The method further includes advancing the belt to a wash and decontamination station of the system and decontaminating the wells of the belt.

### BRIEF DESCRIPTION OF THE DRAWINGS

FIG. 1A is a top view of a matrix of wells formed on a substrate using a die cut technique.

FIG. 1B is a cross-sectional view of a tape with a matrix of wells formed on a substrate using a die cut technique, along line 1B-1B in FIG. 1A.

FIG. 2A is a top view of a tape with a matrix of wells formed on a substrate using a laser technique.

FIG. 2B is a cross-sectional view of a tape with a matrix of wells formed on a substrate using a laser technique, along line 2B-2B in FIG. 2A.

FIG. 3A is a top view of a tape with a matrix of wells formed on a substrate using a thick film depositing technique.

FIG. 3B is a cross-sectional view of a tape with a matrix of wells formed on a substrate using a thick film depositing technique, along line 3B-3B in FIG. 3A.

FIG. 3C is a cross-sectional view of a tape with a matrix of wells formed on a substrate using a thick film depositing technique.

FIG. 4A is a top view of a tape with a matrix wells formed on a substrate.

FIG. 4B is a cross-sectional view of a tape with a matrix wells formed on a substrate using an additive technique, along line 4B-4B in FIG. 4A.

FIG. 4C is a cross-sectional view of a tape with a matrix wells formed on a substrate using a subtractive etching technique.

FIG. 5 is a schematic diagram of a high throughput system employing a reusable belt with a matrix of wells.

FIG. 6A is a bottom view of an embodiment of a reusable belt with a matrix of wells on the bottom of the belt.

FIG. 6B is a cross-sectional view of an embodiment of a reusable belt with a matrix of wells on the bottom of the belt, along line 6B-6B in FIG. 6A.

FIG. 7A is a top view of an embodiment of a reusable belt with a matrix of wells on the top of the belt.

FIG. 7B is a cross-sectional view of an embodiment of a reusable belt with a matrix of wells on the top of the belt, along line 7B-7B in FIG. 7A.

FIG. 8A is a top view of an embodiment of a reusable belt with a matrix of wells on the top of the belt.

FIG. 8B is a cross-sectional view of an embodiment of a reusable belt with a matrix of wells with wells on the top of the belt, along line 8B-8B in FIG. 8A.

FIG. 9 is a schematic diagram of another embodiment of a high throughput system employing a reusable belt with a matrix of wells.

FIG. 10 is a schematic diagram of another embodiment of a high throughput system employing a reusable belt with a matrix of wells.

FIG. 11 is a schematic diagram of another embodiment of a high throughput system employing a reusable belt with a matrix of wells.

FIG. 12 is a schematic diagram of another embodiment of a high throughput system employing a reusable belt with a matrix of wells.

FIG. 13 is a schematic diagram of another embodiment of a high throughput system employing a reusable belt with a matrix of wells.

### DETAILED DESCRIPTION

A system disclosed herein, in one aspect, provides more cost-effective methods of forming disposable tape with a matrix of wells. This provides accurate and controllable methods to introduce wells, recesses, or channels into a substrate to form a tape with a matrix of wells. Another embodiment replaces disposable tape with a matrix of wells with a reusable belt with a matrix of wells. The reusable belt progresses through a high throughput system for biological sample processing and detection, but is not discarded once detection is complete. Instead, the belt progresses through a decontamination regimen in order to remove processed biological material to allow the belt to be re-used for biological sample processing and detection. The high throughput system performs inline sampling, where a biological material is dispensed, reagents are added, the samples may be incubated for a specified amount of time to carry out a reaction, and the reaction may be scanned by a detector to determine the amount of an analyte in the biological material.

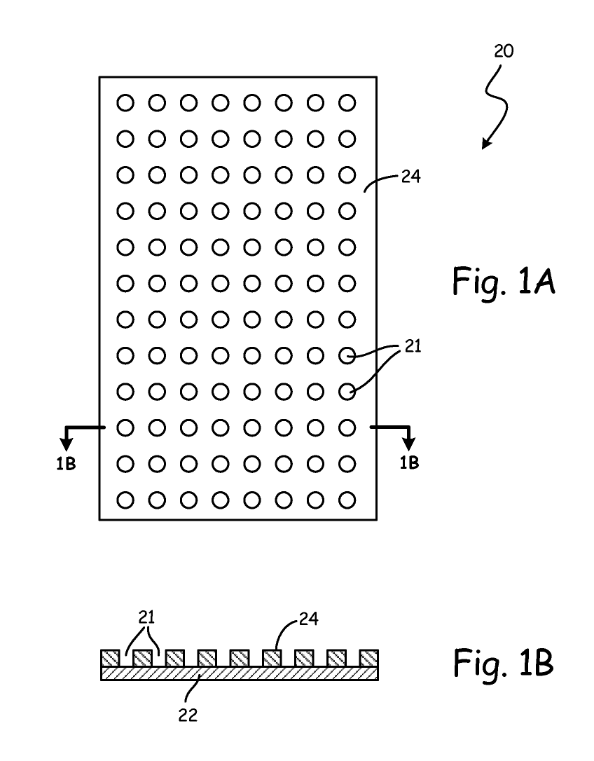

FIGS. 1A and 1B are a top view and a cross-sectional view of tape 20 including matrix of wells 21, substrate 22, and die-cut top layer 24. Matrix of wells 21 is formed on substrate 22 using a die cut technique. Substrate 22 may be a substrate suitable for use as a tape with a matrix of wells. Using die-cut technology, a patterned film is laminated to substrate 22. In an alternative embodiment, hole-punching technology is used to laminate a patterned film to substrate 22. The attachment of a patterned film to substrate 22 can form matrix of wells 21, resulting in die-cut top layer 24 with a bottom layer of substrate 22. Matrix of wells 20 may be formed in an array pattern on substrate 22. In alternative embodiments, the attachment of a pattern to substrate 22 can form a matrix of recesses, channels, or chambers. In one embodiment, this results in a disposable tape with matrix of wells 21 that can be employed in a high throughput system. The disposable tape with matrix of wells 21 can hold or control fluids or materials deposited into matrix of wells 21 for use, for example, in a bioassay or chemical reaction. A cover layer may be applied to contain fluid or material deposits within matrix of wells 20.

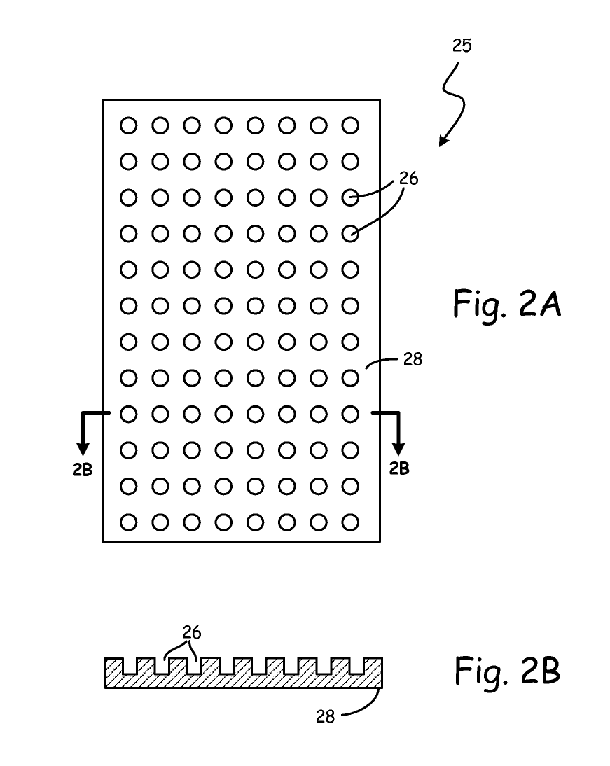

FIGS. 2A and 2B are a top view and a cross-sectional view of tape 25 including matrix of wells 26 and substrate 28. Matrix of wells 26 is formed on substrate 28 using a laser technique. Substrate 28 may be a substrate suitable for use as a tape with a matrix of wells. Using laser technology, such as an excimer laser, matrix of wells 26 is lasered into substrate 28. In an alternative embodiment, a carbon dioxide (CO2) laser is used. An excimer laser can controllably and accurately create matrix of wells 26 in substrate 28, allowing for extremely accurate, simple or complex, geometries to be machined into a flat tape format. Matrix of wells 26 may be formed in an array pattern on substrate 28. The size and volume of matrix of wells 26 can be controlled by the amount of material removed by the excimer laser. Additionally, well density can be controlled through use of the laser technique. In alternative embodiments, a matrix of recesses, channels, or chambers can be lasered into substrate 28. In one embodiment, this results in a disposable tape with matrix of wells 26 that can be employed in a high throughput system. The disposable tape with matrix of wells 26 can hold or control fluids or materials deposited into the wells for use, for example, in a bioassay or chemical reaction. A cover layer may be applied to contain fluid or material deposits within matrix of wells 26.

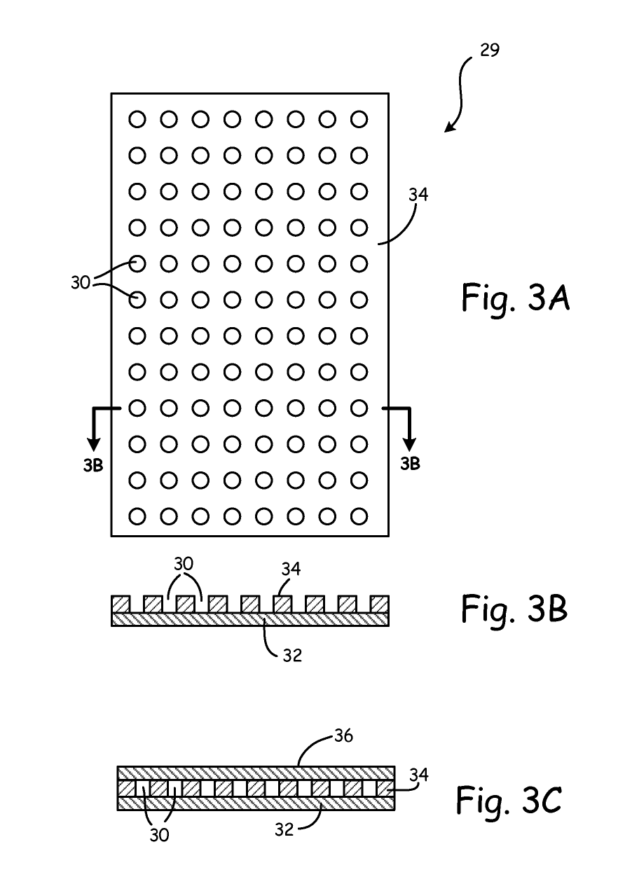

FIGS. 3A-3C are a side view and cross-sectional views of tape 29 including matrix of wells 30, substrate 32, and thick film top layer 34. Matrix of wells 30 is formed on substrate 32 using a thick film depositing technique. Substrate 32 may be a substrate suitable for use as a tape with a matrix of wells. Thick film technology may be used to deposit a thick film layer in a pattern on substrate 32 to form matrix of wells 30 on substrate 32, resulting in thick film top layer 34 with a bottom layer of substrate 32. The pattern may be an array pattern. The bottom of matrix of wells 30 consists of exposed substrate 32. In alternative embodiments, an array of recesses, channels, or chambers can be formed on substrate 32 by depositing a thick film layer in a desired pattern. In one embodiment, this results in a disposable tape with matrix of wells 30 that can be employed in a high throughput system. The disposable tape with matrix of wells 30 can hold or control fluids or materials deposited into matrix of wells 30 for use, for example, in a bioassay or chemical reaction. Cover seal 36 may be applied to contain fluid or material deposits within matrix of wells 30.

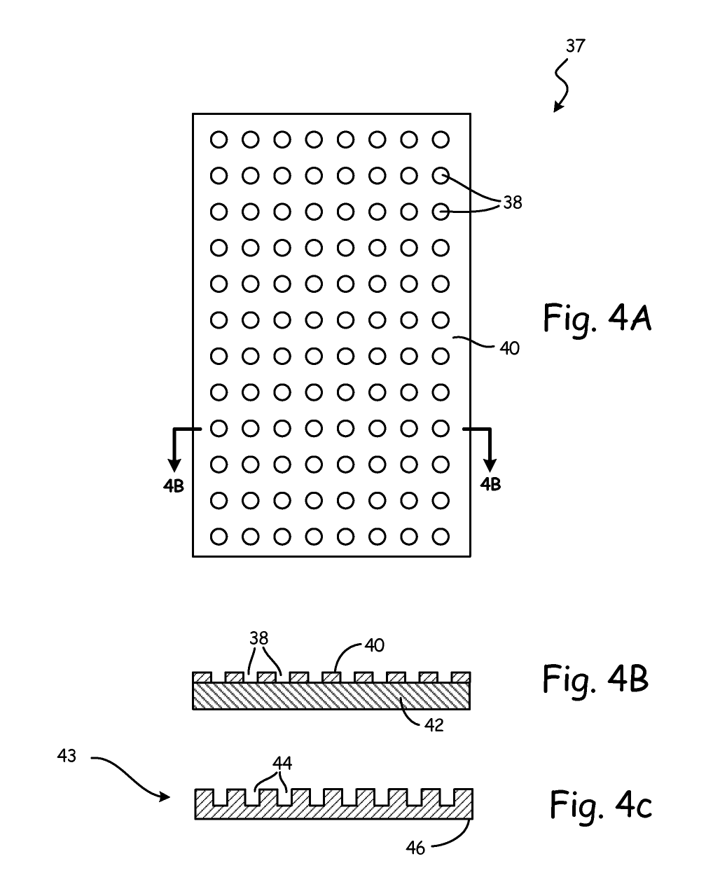

FIGS. 4A-4B are a top view and a cross-sectional view of tape 37 including matrix of wells 38, photoresist top layer 40, and substrate 42. Matrix of wells 38 is formed on substrate 42 using an additive technique. Substrate 42 may be a substrate suitable for use as a tape with a matrix of wells. Matrix of wells 38 may be formed in an array pattern on substrate 42. A photoresist layer is added to substrate 42 in a pattern to form matrix of wells 38 on substrate 42, resulting in photoresist top layer 40 with a bottom layer of substrate 42. The bottom of matrix of wells 38 consists of exposed substrate 42. In an alternative embodiment shown in a cross-sectional view in FIG. 4C, tape 43 includes matrix of wells 44 and substrate 46. Matrix of wells 44 may be etched into substrate 46 using a subtractive technique such as photochemical etching, plasma etching, vapor etching, particle etching, or any other suitable etching technique. Matrix of wells 44 may be etched in an array on substrate 46.

Etching may controllably and accurately create wells in substrates, allowing for extremely accurate, simple or complex, geometries to be machined into a flat tape format. The size and volume of the wells can be controlled by the amount of material removed by etching. Additionally, well density may be controlled. In alternative embodiments, an array of recesses, channels, or chambers can be formed. In one embodiment, this results in tape 37 with matrix of wells 38 or tape 43 matrix of wells 44 that may be employed in a high throughput system. Tape 37 or tape 43 may hold or control fluids or materials deposited into the wells for use, for example, in a bioassay or chemical reaction. A cover seal may be applied to contain fluid or material deposits within matrix of wells 38 or matrix of wells 44.

In an alternative embodiment to the techniques described in FIGS. 1-4, a mechanical embossing technique may be used to emboss dimples into a substrate and displace the substrate material into the surrounding area. This mechanical embossing could be performed using a stamping technique or any other suitable mechanical technique. Mechanical embossing may produce arrays of wells with a range of volumes. For example, small dimples may be produced for reactions encased in oil that require very low sample volumes.

In an alternative embodiment, instead of forming wells, a secondary substrate or coating could be applied to a base substrate using any appropriate technique such that the substrate or coating is capable of capturing samples and reagents. The substrate or coating may, for example, be paper, fabric, or a gel such as a hydrogel or agarose gel. Samples may be added in specific locations on the substrate. The substrate could be preloaded with reagents for a desired chemical reaction and the sample can subsequently be added to the substrate. Alternatively, the substrate may be preloaded with a sample and reagents subsequently added to the substrate.

All of the above techniques can produce a tape with a matrix of wells with a flat bottom. The substrate may be plastic, metal, ceramic, glass, or any other suitable substrate for the appropriate technique. If a cover seal is applied, the tape with a matrix of wells will include both a flat top and a flat bottom. This is advantageous over traditional tape with a matrix of wells, which does not have a flat bottom due to thermoformed wells. A flat top and flat bottom allow imaging techniques for detecting a desired analyte, for example, to be used via either the cover seal or through the bottom layer of the tape with a matrix of wells or both. In some embodiments, magnets, heaters, coolers, vibrations, or other interactive systems may be applied directly to the flat surfaces of either or both the cover seal and the bottom layer of the tape with a matrix of wells to manipulate the fluids or materials deposited in the tape with a matrix of wells wells. In other embodiments, either or both the cover seal and the bottom layer of the tape with a matrix of wells may be imparted with a coating or finish that is metallic, dielectric, refractive, reflective, or absorbent.

The well formation techniques can accurately produce wells that accommodate very low volumes of fluids and particles, such as wells for microfluidic applications. The techniques minimally affect the material chemical properties of substrate materials. Furthermore, these techniques are fast, low cost, and allow flexibility in manufacturing. These techniques may be used to create different formats for the tape with a matrix of wells such as individual arrays, continuous carrier tape including arrays used in a reel-to-reel process, microplate arrays, or slide arrays. The techniques described may also be used to create a matrix of wells on the second aspect of the system disclosed herein, which is a reusable belt with a matrix of wells.

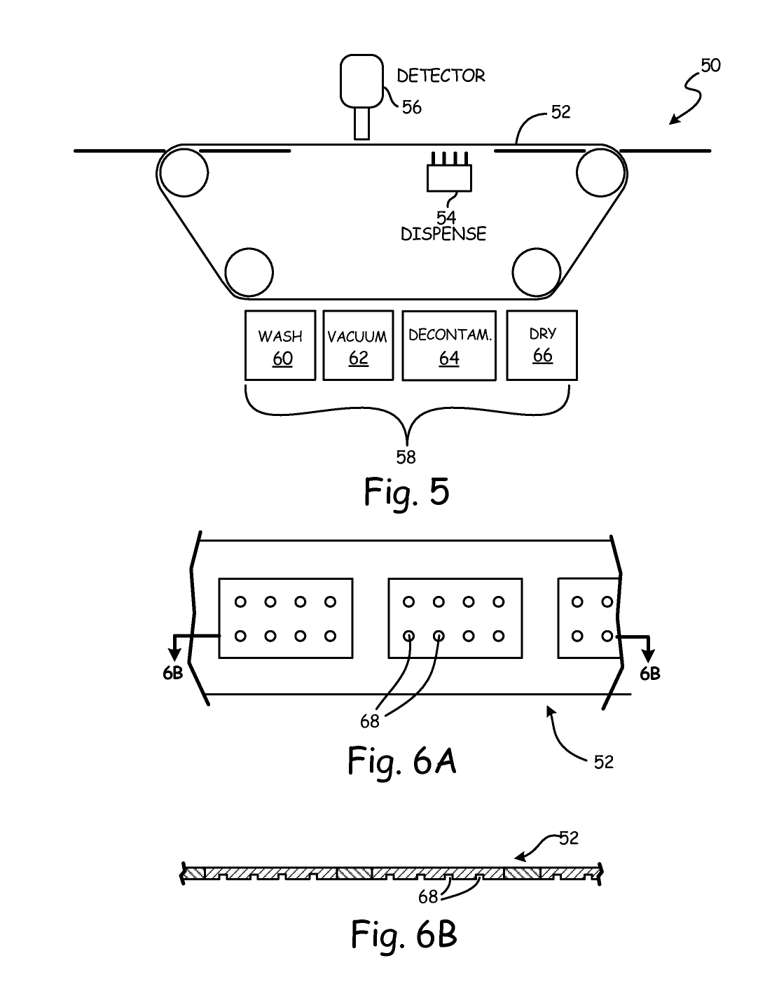

FIG. 5 is a schematic diagram of high throughput system 50 employing reusable belt 52. Reusable belt 52 is a continuous loop/belt of tape with a built-in matrix of reaction wells. Reusable belt 52 can be utilized to process a sample, such as a biological sample, in a high throughput system and subsequently be decontaminated and reused to process a new sample. High throughput system 50 includes reusable belt 52, dispensing station 54, detection station 56, and wash/decontamination station 58. Wash/decontamination station 58 may include wash step 60, vacuum step 62, decontamination step 64, and drying step 66. Wash/decontamination station 58 eliminates the need for disposing of tape due to contamination risks, and allows reusable belt 52 to be used for processing numerous biological samples. Wash/decontamination station 58 provides a tightly controlled environment to control waste products such as amplicons from contaminating other parts of the high throughput system and subsequent samples. In one embodiment, wash/decontamination station 58 may be contained within a separate, sealed chamber. In an alternative embodiment, negative pressure could be used within a separate, sealed chamber to inhibit the possible escape of biological material from wash/decontamination station 58.

A biological sample may be loaded into the matrix of wells of reusable belt 52 and any necessary reagents for a desired reaction may be loaded into the matrix of wells of the reusable belt 52 at dispensing station 54. A reaction can subsequently take place and reusable belt 52 may proceed to detection station 56 where a desired analyte can be detected. Once the detection is complete, reusable belt 52 proceeds to wash/decontamination station 58. The first step in wash/decontamination station 58 is to remove the completed reaction by washing out the matrix of wells of reusable belt 52 in wash step 60 and/or applying a vacuum in vacuum step 62. In an alternative embodiment an air knife or a water knife may be used. In other embodiments, any combination of a wash, a vacuum, an air knife, and a water knife may be used. The reaction wells are systematically washed depending on how the biological sample is processed within high throughput system 50, including DNA amplification, RNA amplification, protein detection, and small molecule detection.

After the bulk reaction is removed, reusable belt 52 moves to more refined decontamination step 64, where decontamination and/or sterilization is performed to ensure that DNA/RNA/protein products are completely removed from the reaction wells of reusable belt 52. Biological products may be removed using chemical solutions like bleach, acid, or any other suitable chemical agent. In alternative embodiments, UV radiation, heat, or cold may be used to remove the biological products. In an alternative embodiment, a chlorine solution may be sprayed in or fogged in, or the reaction wells may be immersed in a chlorine solution. After decontamination step 64 is complete, reusable belt 52 proceeds to drying step 66 where the reaction wells of reusable belt 52 are dried to make sure there is no residual decontamination material in the wells that would inhibit reactions of new samples. Since reusable belt 52 is a continuous loop with reaction wells built in, while some wells are decontaminated in wash/decontamination station 58, decontaminated wells could proceed through the rest of high throughput system 50 to simultaneously process another biological sample.

As stated above, the reaction wells in reusable belt 52 may be formed by using any of the techniques referred to in relation to FIGS. 1-4. Reusable belt 52 may be made of stainless steel or any other suitable metal, which is resilient to rust and degradation. In an alternative embodiment, reusable belt 52 may be made of a material similar to disposable tape with a matrix of wells, such as a polymer. In other embodiments, reusable belt 52 may be made of any other suitable material that can operate in a flexible manner and cycle within high throughput system 50. The format of the reaction wells of reusable belt 52 may be a traditional rectangular array, a radial array, a single well row, or any other matrix format suitable for processing a desired biological material sample. Additionally, reusable belt 52 may be continuous or may be segmented, similar to a bulldozer track. In alternative embodiments, reusable belt 52 may be made of discrete films that are somewhat connected. In other embodiments, reusable belt 52 may be made of array segments that are held together, for example, by a magnet, strapped together, or riveted together.

FIGS. 6A and 6B are a bottom view and a cross-sectional view of an embodiment of reusable belt 52 with matrix of wells 68 with matrix of wells 68 formed on the bottom of reusable belt 52. Matrix of wells 68 may be formed in an array pattern on reusable belt 52. Reusable belt 52 may be transparent such that each of the wells of matrix of wells 68 is visible from the top of reusable belt 52. With matrix of wells 68 on the bottom of reusable belt 52, a reagent can be dispensed from the bottom of reusable belt 52, as shown in FIG. 5. Depending on the reaction taking place in the high throughput system, detection may occur from the bottom or the top of this embodiment of reusable belt 52.

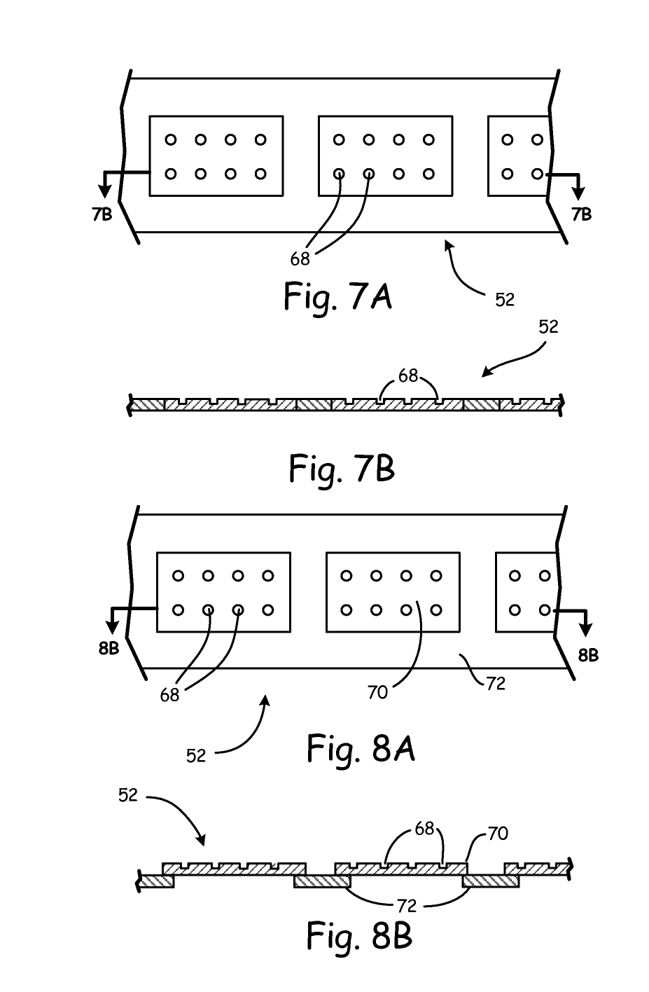

FIGS. 7A and 7B are a top view and a cross-sectional view of another embodiment of reusable belt 52 with matrix of wells 68 formed on the top of reusable belt 52. Matrix of wells 68 may be formed in an array pattern on reusable belt 52. The bottom of reusable belt 52 is flat, thus detection can occur from either the top of reusable belt 52 or the bottom of reusable belt 52.

FIGS. 8A and 8B are a top view and a cross-sectional view of another embodiment of reusable belt 52. Reusable belt 52 includes arrays 70 with matrix of wells 68 and belt portion 72. Belt portion 72 of reusable belt 52 may be made of stainless steel containing gaps or windows. Arrays 70 are configured to be placed over the gaps or windows in reusable belt 52. Arrays 70 may be made of a transparent material such that detection may occur from underneath reusable belt 52.

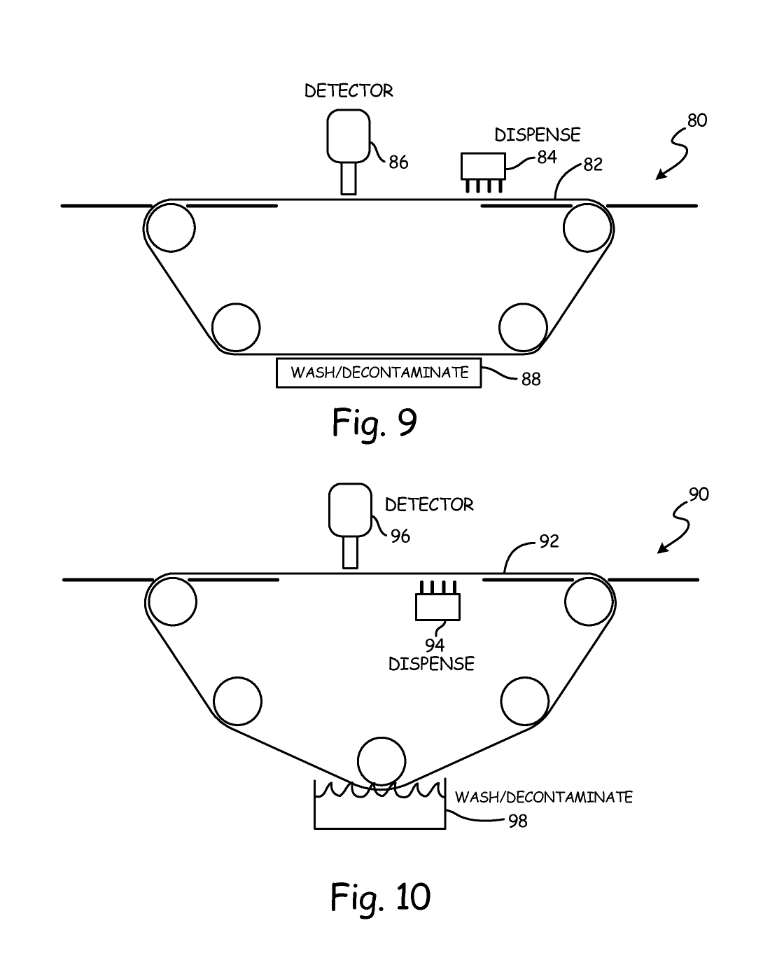

FIG. 9 is a schematic diagram of high throughput system 80 employing reusable belt 82. High throughput system 80 includes top dispensing station 84, detection station 86, and wash/decontamination station 88. High throughput system 80 also allows simultaneous reaction incubation and detection for processes such as real time polymerase chain reaction and isothermal polymerase chain reaction. Since reusable belt 82 is a continuous loop with reaction wells built in, while some wells are decontaminated in wash/decontamination station 88, decontaminated wells could simultaneously proceed through the rest of high throughput system 80 to process another biological sample.

FIG. 10 is a schematic diagram of high throughput system 90 employing reusable belt 92. High throughput system 90 includes bottom dispensing station 94, detection station 96, and wash/decontamination station 98. Wash/decontamination station 98 of this embodiment includes a wash basin to decontaminate the reaction wells of reusable belt 92.

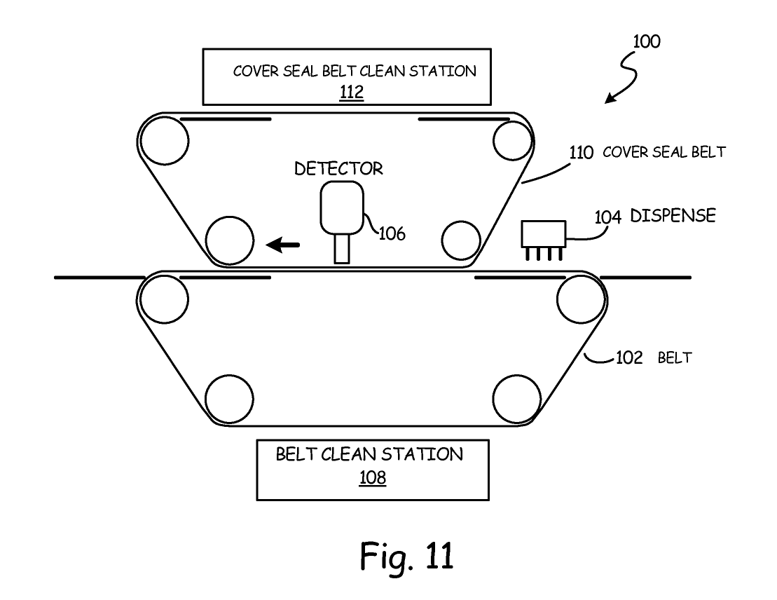

FIG. 11 is a schematic diagram of high throughput system 100 employing reusable belt 102. High throughput system 100 includes dispensing station 104, detection station 106, belt cleaning station 108, cover seal belt 110, and cover seal belt cleaning station 112. A biological sample may be loaded into reusable belt 102 of high throughput system 100 and a reagent may be dispensed at dispensing station 104. Subsequently, a cover seal may be placed from cover seal belt 110 onto reusable belt 102, covering the reaction wells of reusable belt 102. Reusable belt 102 then proceeds to detection station 106, where detection of a desired analyte occurs. The cover seal is then removed by cover seal belt 110, and cover seal belt 110 continues to cover seal belt clean station 112. Reusable belt 102 proceeds to belt cleaning station 108. Thus, both cover seal belt 110 and reusable belt 102 are cleaned and decontaminated and may be reused in high throughput 100 system to process additional biological samples.

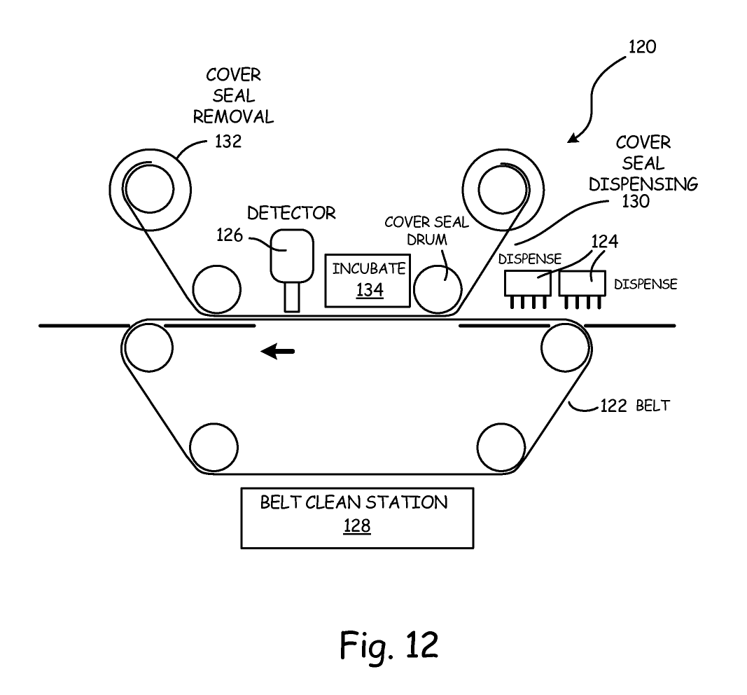

FIG. 12 is a schematic diagram of high throughput system 120 employing reusable belt 122. High throughput system 120 includes two dispensing stations 124, detection station 126, belt cleaning station 128, cover seal dispensing station 130, cover seal removal station 132, and incubation station 134. High throughput system 120 does not use a reusable cover seal. Instead, a sample may be loaded or dispensed into reusable belt 122, one or more reagents may be dispensed in one or more of dispensing stations 124, a cover seal may be placed over reusable belt 122 by cover seal dispensing system 120, and reusable belt 122 may proceed through high throughput system 120. Incubation station 134 allows reusable belt 122 to accumulate, incubate at a constant temperature, or pass through to detection station 136 if incubation is unnecessary for the desired reaction to take place.

After reusable belt 122 passes through detection station 126 and the biological sample analysis is complete, the cover seal is removed by cover seal removal station 132 and the used cover seal is taken up by a cover seal take up. The used cover seal is subsequently disposed. Reusable belt 122 proceeds to belt cleaning station 128, where reusable belt 122 is washed and/or decontaminated and may subsequently be reused in high throughput system 120 to process additional biological samples.

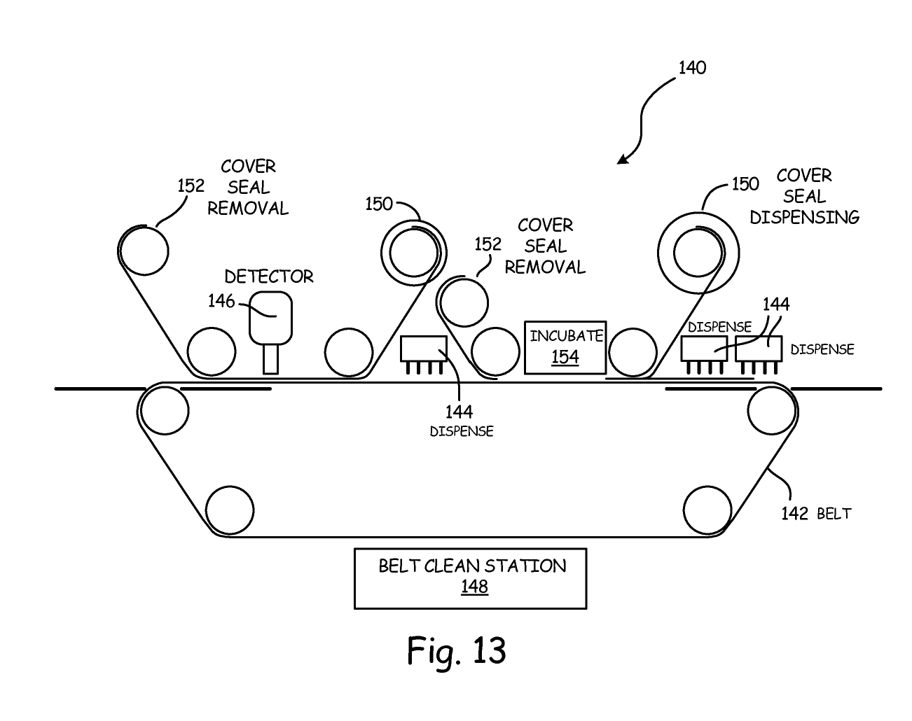

FIG. 13 is a schematic diagram of high throughput system 140 employing reusable belt 142. High throughput system 140 includes three dispensing stations 144, detection station 146, belt cleaning station 148, two cover seal dispensing stations 150, two cover seal removal stations 152, and incubation station 154. A sample may be loaded or dispensed into reusable belt 142, one or more reagents may be dispensed in one or more of the first two dispensing stations 144, a cover seal may be placed over reusable belt 142 by the first cover seal dispensing station 150, and reusable belt 142 may proceed through high throughput system 140. Incubation station 154 reusable belt 142 to accumulate, incubate at a constant temperature, or pass through to the third dispensing station 144 or detection station 146 if incubation is unnecessary for the desired reaction to take place.

The cover seal may subsequently be removed at the first cover seal removal station 150 and reusable belt 142 may proceed to the third dispensing station 144, where additional reagents may be added to the reaction wells. The reaction may be resealed at the second cover seal dispensing station 150, and reusable belt 142 may proceed to detection station 146. After detection, the second cover seal may be removed, taken up, and subsequently disposed at the second cover seal removal station 152. Reusable belt 142 proceeds to belt cleaning station 148, where reusable belt 142 is washed and decontaminated and may subsequently be reused in high throughput system 140 to process additional biological samples.

Although the present invention has been described with reference to preferred embodiments, workers skilled in the art will recognize that changes may be made in form and detail without departing from the spirit and scope of the invention.

1-30. (canceled)

31. A system for processing and analyzing a sample, the system comprising:
a belt that proceeds through the system, the belt including a plurality of wells;
a dispensing station that dispenses the sample and reagents into the plurality of wells of the belt;
a detection station that detects an analyte in the plurality of wells of the belt; and
a wash and decontamination station for decontaminating the plurality of wells of the belt.

32. The system of claim 31, wherein the wash and decontamination station comprises:
a washing station for washing the plurality of wells of the belt;
a vacuum station for applying a vacuum to the plurality of wells of the belt;
a decontamination station for applying a chemical solution or radiation to the plurality of wells of the belt; and
a drying station for drying the plurality of wells of the belt.

33. The system of claim 31, wherein the wash and decontamination station is contained within a sealed chamber.

34. The system of claim 31, wherein the plurality of wells of the belt is arranged in a plurality of matrices.

35. The system of claim 34, wherein the belt includes a plurality of gaps and each matrix of the plurality of matrices covers one of the plurality of gaps of the belt.

36. The system of claim 31, wherein the plurality of wells is on a top side of the belt and the dispensing station is positioned above the belt such that the dispensing station dispenses the sample and the reagents into the plurality of wells of the belt from above the belt.

37. The system of claim 36, wherein the detection station is positioned above the belt such that the detection station detects the analyte in the plurality of wells of the belt from above the belt.

38. The system of claim 36, wherein the detection station is positioned below the belt such that the detection station detects the analyte in the plurality of wells of the belt from below the belt.

39. The system of claim 31, wherein the wash and decontamination station includes a wash basin for submerging the belt to decontaminate the plurality of wells.

40. The system of claim 31, and further comprising an incubation station for incubating the belt so that a reaction can take place in the plurality of wells of the belt.

41. The system of claim 31, and further comprising a cover seal dispensing station for applying a cover seal to the plurality of wells of the belt.

42. The system of claim 41, and further comprising a cover seal removal station for removing the cover seal from the plurality of wells of the belt.

43. A method for processing and analyzing a sample in a system, the method comprising:
advancing a belt with a plurality of wells through the system to a dispensing station of the system;
dispensing a sample and reagents into the plurality of wells of the belt;
advancing the belt to a detection station of the system;
detecting an analyte in the sample in the plurality of wells of the belt;
advancing the belt to a wash and decontamination station of the system; and
decontaminating the plurality of wells of the belt.

44. The method of claim 43, wherein decontaminating the plurality of wells of the belt is selected from the group consisting of washing the plurality of wells of the belt, applying a vacuum to the plurality of wells of the belt, applying a chemical solution or radiation to the plurality of wells of the belt, and combinations thereof.

45. The method of claim 44, wherein decontaminating the plurality of wells of the belt further includes drying the plurality of wells of the belt.

46. The method of claim 43, and further comprising:
advancing the belt to an incubation station of the system after dispensing the sample and reagents into the plurality of wells of the belt; and
incubating the belt so that a reaction can take place in the plurality of wells of the belt prior to advancing the belt to the detection station of the system.

47. The method of claim 43, and further comprising:
advancing the belt to a cover seal dispensing station of the system after dispensing the sample and reagents into the plurality of wells of the belt; and
applying a cover seal to the plurality of wells of the belt prior to advancing the belt to the detection station of the system.

48. The method of claim 47, and further comprising:
advancing the belt to a cover seal removal station after detecting an analyte in the sample in the plurality of wells of the belt; and
removing the cover seal from the plurality of wells of the belt prior to advancing the belt to the wash and decontamination station of the system.

49. The method of claim 47, and further comprising:
advancing the belt to an incubation station of the system after applying the cover seal to the plurality of wells of the belt; and
incubating the belt so that a reaction can take place in the plurality of wells of the belt prior to advancing the belt to the detection station of the system.

50. The method of claim 49, and further comprising:
advancing the belt to a cover seal removal station after detecting an analyte in the sample in the plurality of wells of the belt; and
removing the cover seal from the plurality of wells of the belt prior to advancing the belt to the wash and decontamination station of the system.
